(19) United States
(12) Patent Application Publication
(10) Pub. No.: US 2014/0076944 A1
(43) Pub. Date: Mar. 20, 2014

(54) "Willie"

(71) Applicant: Gregory Marra, West Long Branch, NJ (US)

(72) Inventor: Gregory Marra, West Long Branch, NJ (US)

(21) Appl. No.: 13/562,148

(22) Filed: Sep. 19, 2012

(51) Int. Cl. A01K 97/10

(52) U.S. Cl. CPC A01K 97/10
USPC 224/222

(57) ABSTRACT

“The Willie” is a Fishing Rod Caddie which attaches to the leg of any angler to holster a fishing rod for ease of use. This will benefit the angler by not having to put a rod down to service the pole. The Caddie is also waterproof, so it will be durable to weather elements and be a long term tool for people fishing.

“The Willie” is a fresh water Fishing Rod Caddie strapped to leg or legs, (Anglers' preference). The Caddie wraps around the leg and holds the rod upright. “The Willie” will assure one can easily bait and lure transfer without having the need to hold rod in one hand under arm, placing it down on ground, or leaving it against a tree or shrubs. Also useful when carrying two rods; Angers can use the caddy for one rod while fishing with the other. Especially beneficial at lakes or streams where there are tight fishing areas.

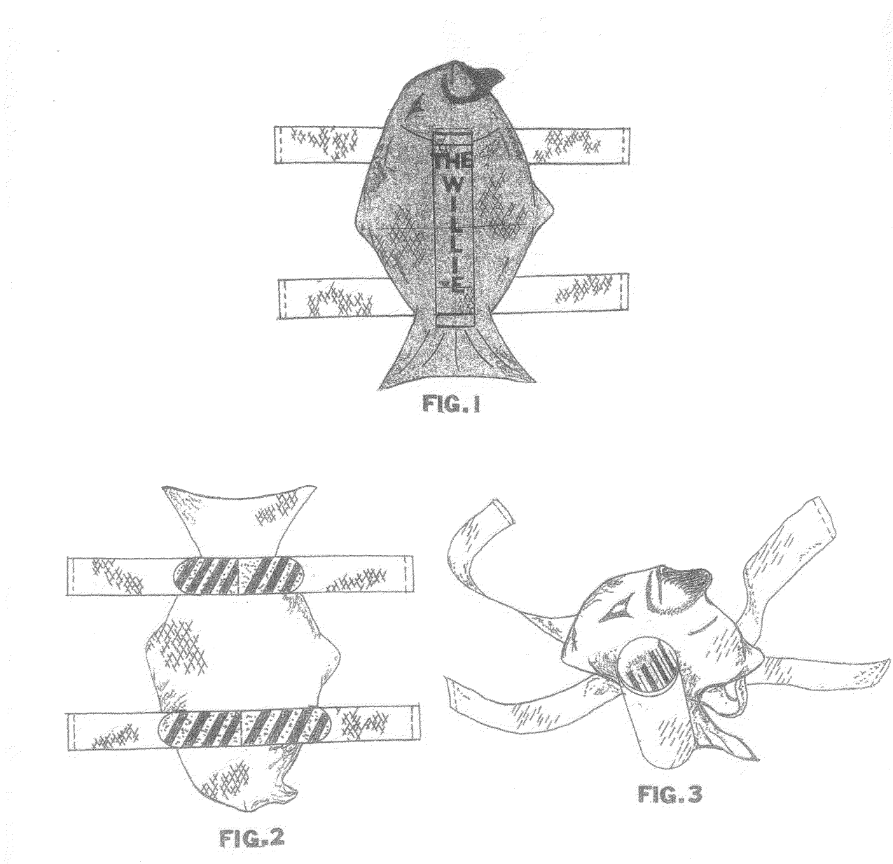

FIG. 1: Front elevation view of a Freshwater Fishing Rod Caddy called “The Willie” showing my design;

FIG. 2: Real elevation view shown thereof;

FIG. 3: Top angle elevation view showing tube for fishing rod handle accessibility and strapping for leg.

1. “The Willie” is a fresh water Fishing Rod Caddie strapped to leg or legs, (Angers' preference) that wraps around the leg and holds the rod upright.

2. “The Willie” will assure one can easily bait and lure transfer without having the need to hold rod in one hand under arm, placing it down on ground, or leaving it against a tree or shrubs (or useful when carrying two rods).
